(19) United States
(12) Patent Application Publication
(10) Pub. No.: US 2008/0112565 A1
(43) Pub. Date: May 15, 2008

(54) METHOD OF INSERTING VECTOR INFORMATION FOR ESTIMATING VOICE DATA IN KEY RE-SYNCHRONIZATION PERIOD, METHOD OF TRANSMITTING VECTOR INFORMATION, AND METHOD OF ESTIMATING VOICE DATA IN KEY RE-SYNCHRONIZATION USING VECTOR INFORMATION

(75) Inventors: TaekJun Nam, Teajon (KR); Byeong-Ho Ahn, Teajon (KR); Ki-Hong Kim, Teajon (KR); Yongick Chung, Teajon (KR); Sang-Yi Yi, Teajon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Taejon (KR)

(21) Appl. No.: 11/745,402

(22) Filed: May 7, 2007

(30) Foreign Application Priority Data
Nov. 13, 2006 (KR) 10-2006-011186
Mar. 15, 2007 (KR) 10-2007-0025571

(51) Int. Cl. H04K 1/00

(52) U.S. Cl. 380/274

(57) ABSTRACT

Disclosed are a method of inserting vector information for estimating voice data in a key re-synchronization period, a method of transmitting vector information, and a method of estimating voice data in a key re-synchronization period using vector information, capable of estimating the voice data that corresponds to a silent period occurring in a key re-synchronization process when an encrypted digital voice is transmitted in a unidirectional wireless communication environment. A transmitter side inserts accumulation information (i.e., vector information) of a voice change direction of the transmitted previous frame in a key re-synchronization frame, using a voice feature that draws a sine wave, when making the key re-synchronization frame for the re-synchronization, and transmits the key re-synchronization frame with the vector information inserted thereto. A receiver side estimates the voice data value in the key re-synchronization period using the accumulation information (i.e., vector information) in the voice change direction and slopes of the received voice data, to minimize the difference between the original voice and the estimated voice.

### BACKGROUND OF THE INVENTION

1. Field of the Invention

The present invention relates to a method of inserting vector information for estimating voice data in a key re-synchronization period, a method of transmitting vector information, and a method of estimating voice data in a key re-synchronization period using vector information, capable of estimating the voice data that corresponds to a silent period occurring in a key re-synchronization process when an encrypted digital voice is transmitted in a unidirectional wireless communication environment. More particularly, the present invention relates to a method of inserting vector information, which is constructed by extracting voice change direction information from a voice feature that draws a sine wave varying non-abruptly, into a key re-synchronization frame, a method of transmitting the vector information, and a method of estimating voice data in a silent period occurring in a key re-synchronization process using the vector information.

2. Background of the Related Art

In a conventional communication method, a key re-synchronization period is processed in a manner that key data is processed as voice data or the previous voice data is reused in a key re-synchronization process. However, this method causes a great difference between the original voice and the output voice, and thus a viewer clearly recognizes a loss of sound quality in the key re-synchronization period.

Particularly, since data is transmitted only in one direction in a unidirectional wireless environment, it is impossible to confirm whether the data has been normally received. Accordingly, if a receiving side cannot receive initial key information in the case where encrypted data is transmitted in such an environment, all data during the corresponding session cannot be decoded.

In order to solver such problems of late participation problem, a key re-synchronization method for periodically transmitting key information is used for encrypted communications in a unidirectional wireless environment. If the key re-synchronization method is used in a state that data which is transmitted and received through the encrypted communications is a digitalized voice, a silent period as long as the re-synchronization period occurs. Since this silent period occurs periodically, it deteriorates the communication quality of a receiver side.

The present invention relates to a technology of estimating voice data value in a silent period of a key re-synchronization period in unidirectional wireless encryption communications, and also relates to a technology of correcting a lossy frame.

As a method of processing a frame loss occurring during transmission of voice data in a unidirectional wireless communications such as HAM, splicing, silence substitution, noise substitution, repetition, and so forth, can be used.

These techniques are to estimate the value of the lost voice frame in the unidirectional wireless communications. Splicing is a method of superimposing two adjacent frames, and has the drawback in that no gap occurs due to the loss, but the timing of streams is broken. Silence substitution is a method of adding silence to the lost period. However as the size of the lossy packet increased, its performance deteriorates.

Noise substitution is a method of restoring an omitted voice signal using surrounding signals in the case where noise is added to a part in which the voice signal is omitted. This method uses human capability of phoneme restoration, which may severely differ each and every person. Repetition is a method of repeatedly inserting most recently received voice signal in a voice-lost period. This method has the drawback in that if the frame is lengthened, sound is also lengthened.

In addition, there is a technique that restores silence in a voice-lost period by using status information of a voice compression codec. Since this method uses the status information which may differ for each codec, it entirely depends on the codec, and an amount of computation is greatly increased.

### SUMMARY OF THE INVENTION

Accordingly, the present invention is directed to a method of inserting vector information for estimating voice data in a key re-synchronization period, a method of transmitting vector information, and a method of estimating voice data in a key re-synchronization period using vector information, which substantially obviate one or more problems due to limitations and disadvantages of the related art.

It is an object of the present invention to provide a method of constructing vector information using a sine-wave voice feature and inserting the vector information in a key re-synchronization period and a method of transmitting the vector information in order to estimate voice data in the key re-synchronization period in a unidirectional wireless communication environment.

It is another object of the present invention to provide a method of estimating a voice data value that corresponds to a silent period in a key re-synchronization period, which periodically occurs, using vector information that is voice change direction information in a unidirectional wireless communication environment.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In order to achieve the above objects, there is provided a method of inserting vector information for estimating voice data in a key re-synchronization period in a transmitter side of encrypted digital voice communications using a unidirectional wireless environment, according to embodiments of the present invention, which comprises deleting the voice data in the key re-synchronization period if a key re-synchronization time arrives with respect to a frame to be transmitted; obtaining a difference between voice data of a present frame and voice data of a previous frame, and constructing the vector information with (+, −) information that is the result of obtaining the difference; and inserting the vector information in the key re-synchronization period from which the voice data has been deleted.

In another aspect of the present invention, there is provided a method of transmitting vector information for estimating voice data in a key re-synchronization period in a transmitter side of encrypted digital voice communications using a unidirectional wireless environment, which comprises encoding the voice data by vocoding an input voice; judging whether a key re-synchronization time arrives with respect to the encoded voice data; generating a key re-synchronization frame by inserting the vector information composed of voice change direction information in the voice data according to the result of judgment, and generating a voice frame from the voice data; and transmitting the generated key re-synchronization frame and the voice frame.

In still another aspect of the present invention, there is provided a method of estimating voice data in a key re-synchronization period using vector information in a receiver side of encrypted digital voice communications using a unidirectional wireless environment, which comprises analyzing a type of a received frame by analyzing a header of the frame; extracting key re-synchronization information and the vector information from a transmitted key re-synchronization frame if the received frame is the key re-synchronization frame; performing a key re-synchronization using the extracted key re-synchronization information, obtaining and comparing the vector information and a slope of the voice data of the received frame; if voice change direction information analyzed from the vector information and the slope are in the same direction, extracting a voice data value on the slope line, while otherwise, extracting the voice data value on a line that is symmetrical to the slope line; and estimating the voice data in the key re-synchronization period with the extracted voice data value, and decoding the voice data to output corresponding voice.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating the entire construction of an apparatus for estimating voice data in a key re-synchronization period using vector information according to an embodiment of the present invention;

FIG. 2 is a flowchart schematically illustrating a process of inserting vector information so that voice data in a key re-synchronization period can be estimated in a transmitter side according to an embodiment of the present invention;

FIG. 3 is a flowchart schematically illustrating a process of estimating voice data of a key re-synchronization period by extracting vector information in a receiver side according to an embodiment of the present invention; and

FIGS. 4A and 4B are views schematically illustrating a process of estimating voice data value in a silent period of a key re-synchronization period using vector information in an apparatus for estimating the voice data in the key re-synchronization period according to an embodiment of the present invention, wherein FIG. 4A shows that a transmitter side constructs and inserts the vector information, and FIG. 4B shows that a receiver side extracts the vector information and estimates voice data value in the silent period of the key re-synchronization period.

### DETAILED DESCRIPTION OF THE PREFERRED EMBODIMENT

A method of inserting vector information for estimating voice data in a key re-synchronization period, a method of transmitting vector information, and a method of estimating voice data in a key re-synchronization period using vector information according to the preferred embodiment of the present invention will now be explained in detail with reference to the accompanying drawings.

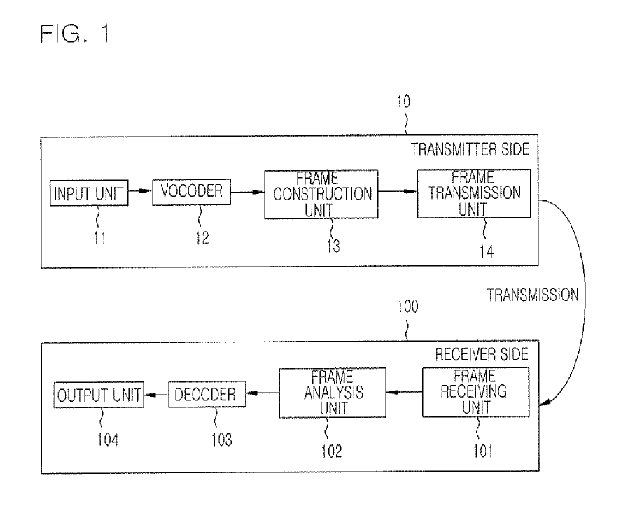

FIG. 1 is a view illustrating the entire construction of an apparatus for estimating voice data in a key re-synchronization period using vector information according to an embodiment of the present invention.

Referring to FIG. 1, the apparatus for estimating voice data in a key re-synchronization period according to an embodiment of the present invention is briefly composed of a transmitter side 10 and a receiver side 100.

The transmitter side 10 includes an input unit 11 for receiving an input of voice from a microphone, a vocoder 12 for encoding the input voice by vocoding the input voice, a frame construction unit 13 for constructing a key re-synchronization frame and a voice frame by judging the key re-synchronization period with respect to the encoded voice data, and a frame transmission unit 14 for transmitting the constructed frames.

The frame construction unit 13 obtains a difference between the present voice data and just previous voice data, and continuously accumulates and stores voice change direction (+, −) information that is the result of obtaining the difference.

In addition, when generating the key re-synchronization frame for transmitting the key re-synchronization information, the frame construction unit 13 deletes the voice data in the key re-synchronization period, constructs the vector information with the accumulated voice change direction (+, −) information, and then inserts the vector information into the key re-synchronization period together with the key re-synchronization information. Then, the frame construction unit 13 transmits the generated key re-synchronization frame to the receiver side 100. Also, the frame construction unit inserts the vector information into a voice frame when the voice frame is transmitted.

That is, the frame construction unit 13 accumulates and stores the voice change direction (+, −) information of the voice data, and when the voice is transmitted, it judges whether a key re-synchronization time arrives with respect to the voice data to be transmitted. If the key re-synchronization time arrives, the frame construction unit 13 constructs the vector information with the stored voice change direction (+, −) information, and generates the key re-synchronization frame by inserting the vector information into the key re-synchronization period.

However, if the key re-synchronization time does not arrive, the frame construction unit 13 constructs the voice frame for the voice data to be transmitted, and inserts the vector information into the voice frame,

Here, the vector information may be constructed only to discriminate between (+) and (−) directions. For example, it is possible to map (+) and (−) on “1” and “0”, respectively. Accordingly, various kinds of methods for discriminating between (+) and (−) can be used to construct the vector information.

On the other hand, the receiver side 102 includes a receiving unit for receiving frames transmitted from the transmitter side 10, a frame analysis unit 102 for analyzing the type of a frame by judging the existence/nonexistence of the key re-synchronization information of the received frame, and if the received frame is the key re-synchronization frame, estimating a voice data value that corresponds to a silent period of the key re-synchronization period, a decoder 103 for decoding the voice data to produce a voice signal, and an output unit 104 for outputting the voice signal.

The frame analysis unit 102 judges the existence/nonexistence of the key re-synchronization information by analyzing a header of the received frame. If the key re-synchronization information exists in the header, the frame analysis unit judges the existence of the key re-synchronization frame, and extracts the vector information from the frame.

Then, the frame analysis unit 102 obtains slopes of voice data from the previous frames recently received, and calculates the voice data value in the key re-synchronization period using the obtained slopes of the voice data and the extracted vector information of the voice data.

That is, if the extracted vector information of the voice data corresponds to (+), the frame analysis unit takes the voice data value in the key re-synchronization period from the obtained slopes of the voice data, while if the vector information corresponds to (−), it obtains a slope that is symmetrical to the obtained slope of the voice data and takes the voice data value in the key re-synchronization period on the slope line.

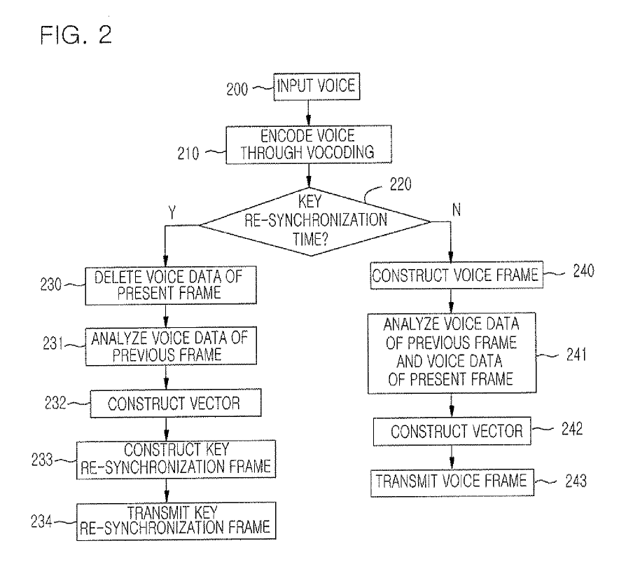

FIG. 2 is a flowchart schematically illustrating a process of inserting vector information so that voice data in a key re-synchronization period can be estimated in a transmitter side 10 according to an embodiment of the present invention.

Voice 200 inputted through the input unit 11 such as a microphone is encoded to voice data through a vocoding process (step 210).

It is judged whether the key re-synchronization time arrives with respect to the frame of the voice data to be transmitted (step 220), and if the key re-synchronization time arrives (“Y” at step 220), the corresponding voice data of the present frame is removed (step 230). Then, the voice change direction (+, −) information is obtained from the difference between the voice data of the previous from and the voice data of the present frame (step 231).

If the voice data value is in an increasing direction, the voice change direction (+, −) information is continuously increased, while if the voice data value is in a decreasing direction, the voice change direction (+, −) information is continuously decreased, due to the waveform characteristic of a sine-wave voice. If the difference between the present voice data and the just previous voice data is (+), the voice data is in the increasing direction, while if the difference is (−), the voice data is in the decreasing direction.

The vector information is constructed by the extracted voice change direction (+, −) information of the voice data (step 232), the key re-synchronization frame is constructed by inserting the vector information into a period, from which the voice data is deleted, together with the key re-synchronization information (step 233), and the constructed key re-synchronization frame is transmitted (step 234).

If the key re-synchronization time does not arrive (“N” at step 220), the voice frame is constructed using the voice data (step 240), and the vector information is constructed by analyzing the voice data of the previous frame and the present frame (step 241). The voice frame and the vector information are stored in an internal memory (not illustrated) of the transmitter side (step 242), and then the constructed voice frame is transmitted (step 243).

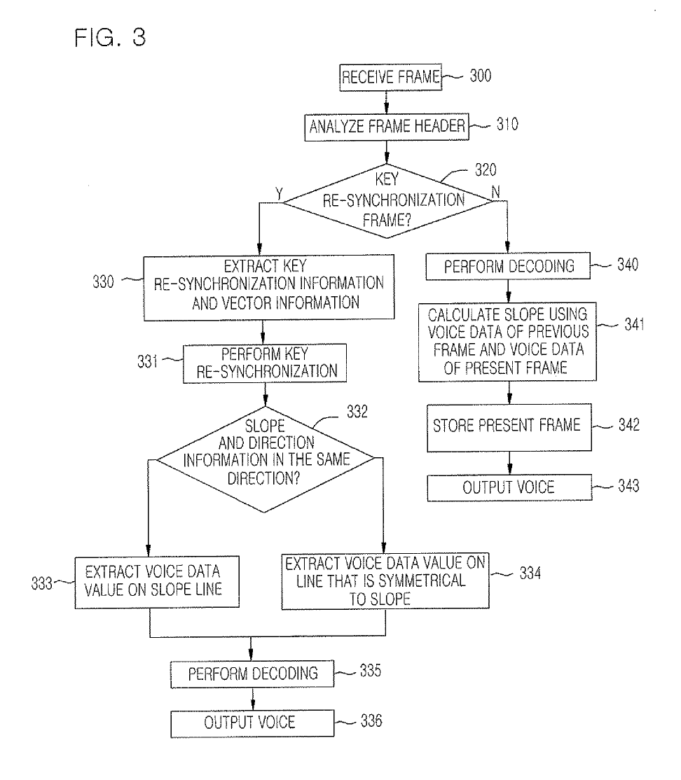

FIG. 3 is a flowchart schematically illustrating a process of estimating voice data of a key re-synchronization period by extracting vector information in a receiver side 100 according to an embodiment of the present invention.

The receiving side 100 receives the transmitted frame (step 300), and analyzes the type of the received frame (step 320) by analyzing the header of the received frame (step 301).

If the received frame is the key re-synchronization frame (“Y” at step 320) as a result of analysis, the receiving side extracts key re-synchronization information and vector information composed of voice change direction (+, −) information from the received frame (step 330).

The receiving side performs the key re-synchronization using the extracted key re-synchronization information (step 331), and judges whether the slope and the voice change direction of the vector information are the same direction by comparing the slope information and the vector information obtained from the voice data of the received frame (step 332).

If the slope obtained from the voice data of the received frame that is stored in an internal memory (not illustrated) of the receiver side and the voice change direction of the vector information are the same direction (“Y” at step 332), the voice data value in a silent period is extracted on the slope line obtained from the voice data of the received frame that is stored in the internal memory of the receiver side (step 333).

If they are not the same direction (“N” at step 332) as a result of judgment, a slope that is symmetrical to the slope obtained from the voice data of the received frame is obtained, and the voice data value in the silent period is extracted on the symmetric slope line (step 334). The extracted voice data value is estimated as the voice data in the silent period of the key re-synchronization period, and outputted as voice (step 336) through the decoding process (step 335).

On the other hand, if the received frame is not the key re-synchronization frame (“N” at step 320) as a result of judgment, the voice data received through a decoding process is provided as a voice signal (step 340). Then, the slope of the present voice data is calculated and stored using the previous frame and the present frame (step 341), and the present frame is stored in the internal memory of the receiver side (step 342) in order to use the present frame later. Then, the received voice signal is outputted as an actual voice (step 343).

Accordingly, the receiver side 100 can estimate the voice data value, being close to the original voice, in the silent period occurring during the key re-synchronization in a unidirectional wireless communication environment by using the change ratio, i.e., the slope, of the voice data values of the received voice frames and the voice change direction information of the extracted vector information of the voice data.

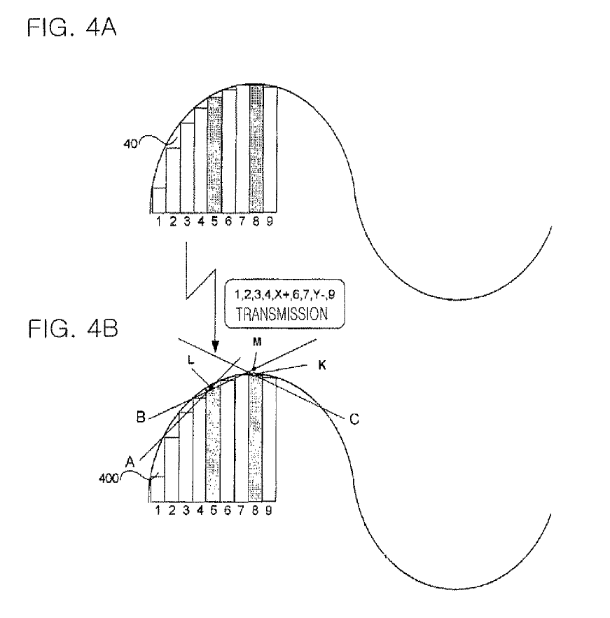

FIGS. 4A and 4B are views schematically illustrating a process of estimating voice data value in a silent period of a key re-synchronization period using vector information in an apparatus for estimating the voice data in the key re-synchronization period according to an embodiment of the present invention. Particularly, FIG. 4A shows that a transmitter side constructs and inserts the vector information, and FIG. 4B shows that a receiver side extracts the vector information and estimates voice data value in the silent period of the key re-synchronization period.

Referring to FIGS. 4A and 4B, it is assumed that period No. 5 and No. 8 correspond to key re-synchronization times. If the key re-synchronization time arrives in the process of encoding a sine-wave voice in the transmitter side 10, voice data in the period No. 5 and No. 8 that correspond to the key re-synchronization times is deleted, and replaced by the key re-synchronization information.

That is, the voice data of No. 5 is replaced by the voice change direction (+) obtained using the difference between the voice data of No. 4 and the voice data of No. 5, and key re-synchronization information X. The voice data of No. 8 is replaced by the voice change direction (+) obtained using the difference between the voice data of No. 7 and the voice data of No. 8, and key re-synchronization information Y. The data as reconstructed above is transferred to the receiver side 100.

If the key re-synchronization data corresponding to the period No. 5 arrives, the receiver side 100 estimates it as the voice data value positioned on line A since the slope value (+) obtained using the voice data of period No. 3 and No. 4 is equal to the voice direction (+) information in the received frame.

If the key re-synchronization data corresponding to the period No. 8 arrives, the receiver side 100 estimates it as the voice data value positioned on line C that is symmetrical to line B since the slope value (+) obtained using the voice data of period No. 6 and No. 7 is different from the voice direction (+) information in the received frame.

Specifically, in the case of the period No. 8, since the slope value (+) calculated from the voice data of period No. 6 and No. 7 is different from the voice direction (+) information of the period No. 8, the line C that is symmetrical to the line B is calculated, and then the voice data value positioned on the line C is estimated.

As described above, according to the present invention, the voice data value in the silent period occurring due to a periodic key re-synchronization is similarly estimated in a directional wireless environment by using the feature of the voice data value that shows a gentle change, and thus the communication quality in the receiver side can be improved. In addition, since the method according to the present invention requires almost no additional information for correcting the voice and requires a relatively small amount of computation in comparison to the conventional method, no additional load is applied to the system.

While the system and method for transmitting cyber thread information in real time according to the present invention has been described and illustrated herein with reference to the preferred embodiment thereof, it will be understood by those skilled in the art that various changes and modifications may be made to the invention without departing from the spirit and scope of the invention, which is defined in the appended claims.

What is claimed is:

1. A method of inserting vector information for estimating voice data in a key re-synchronization period in a transmitter side of encrypted digital voice communications using a unidirectional wireless environment, the method comprising:
deleting the voice data in the key re-synchronization period if a key re-synchronization time arrives with respect to a frame to be transmitted;
obtaining a difference between voice data of a present frame and voice data of a previous frame, and constructing the vector information with (+, −) information that is the result of obtaining the difference; and
inserting the vector information in the key re-synchronization period from which the voice data has been deleted.

2. The method of claim 1, wherein the (+, −) information is used as voice change direction information in a manner that the (+) information corresponds to the voice data that is in an increasing direction and (−) information corresponds to the voice data that is in a decreasing direction, using a voice feature that draws a sine wave.

3. A method of transmitting vector information for estimating voice data in a key re-synchronization period in a transmitter side of encrypted digital voice communications using a unidirectional wireless environment, the method comprising:
encoding the voice data by vocoding an input voice;
judging whether a key re-synchronization time arrives with respect to the encoded voice data;
generating a key re-synchronization frame by inserting the vector information composed of voice change direction information in the voice data according to the result of judgment, and generating a voice frame from the voice data; and
transmitting the generated key re-synchronization frame and the voice frame.

4. The method of claim 3, wherein if the key re-synchronization time arrives as a result of judgment, the key re-synchronization frame is generated by removing the voice data from the key re-synchronization period and inserting the vector information composed of the voice change direction information in the key re-synchronization period together with the key re-synchronization information.

5. The method of claim 3, wherein if the key re-synchronization time does not arrive as a result of judgment, the voice frame that includes the voice data is generated.

6. The method of claim 3, wherein the vector information is obtained by a difference between the voice data of the present frame and the voice data of the previous frame, and is constructed in a manner that the (+) information corresponds to the voice data that is in an increasing direction and (−) information corresponds to the voice data that is in a decreasing direction, using a voice feature that draws a sine wave.

7. A method of estimating voice data in a key re-synchronization period using vector information in a receiver side of encrypted digital voice communications using a unidirectional wireless environment, the method comprising:
analyzing a type of a received frame by analyzing a header of the frame;
extracting key re-synchronization information and the vector information from a transmitted key re-synchronization frame if the received frame is the key re-synchronization frame;
performing a key re-synchronization using the extracted key re-synchronization information, obtaining and comparing the vector information and a slope of the voice data of the received frame;
if voice change direction information analyzed from the vector information and the slope are in the same direction, extracting a voice data value on the slope line, while otherwise, extracting the voice data value on a line that is symmetrical to the slope line; and
estimating the voice data in the key re-synchronization period with the extracted voice data value, and decoding the voice data to output corresponding voice.

8. The method of claim 7, wherein if the received frame is not the key re-synchronization frame as a result of judgment, the received voice data is decoded, and the slope of the present voice data is calculated and stored using the previous frame and the present frame.

9. The method of claim 7, wherein the vector information is (+, −) voice change direction information obtained by a difference between the voice data of the present frame and the voice data of the previous frame, and is constructed in a manner that the (+) information corresponds to the voice data that is in an increasing direction and (−) information corresponds to the voice data that is in a decreasing direction, using a voice feature that draws a sine wave.
